(19) United States
(12) Patent Application Publication
(10) Pub. No.: US 2007/0058557 A1
(43) Pub. Date: Mar. 15, 2007

(54) Method and apparatus for scheduling data transmissions based on a traffic data pattern model

(75) Inventors: Angelo Cuffaro, Laval (CA); Howard E. Goldberg, Wynnewood, PA (US); Michel Desgagne, St. Hubert (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/300,213

(22) Filed: Dec. 14, 2005

Related U.S. Application Data
(60) Provisional application No. 60/717,444, filed on Sep. 15, 2005.

(51) Int. Cl. H04J 1/16; H04Q 7/24

(52) U.S. Cl. 370/252; 370/338

(57) ABSTRACT

A communication network includes at least two nodes which exchange data packets. The communication network further includes a processor and a data transmission scheduling unit. The processor monitors the data packets, collects and analyzes information contained in the data packets, and identifies a particular service based on the monitoring of the data packets and the analysis of the information contained in the data packets. The data transmission scheduling unit schedules the transmission of data packets exchanged between the nodes based on a predefined traffic data pattern model selected by the processor from a plurality of predefined traffic data pattern models which is most appropriate for the identified service. Alternatively, a neural network is used to identify the service and select the most appropriate traffic data pattern model used by the data transmission scheduling unit to schedule the transmission of the data packets.

### CROSS REFERENCE TO RELATED APPLICATION

This application claims the benefit of U.S. Provisional Patent Application No. 60/717,444 filed Sep. 15, 2005, which is incorporated by reference as if fully set forth.

### FIELD OF INVENTION

The present invention is related to the monitoring and control of data packet transmissions between at least two nodes of a communication system. More particularly, the present invention is related to the analysis of the contents of the data packets to identify a service, such that an appropriate traffic data pattern model may be selected or generated for use in scheduling the data packet transmissions.

### BACKGROUND

In wireless communication systems such as IEEE 802.11a/b/g networks, there is no provision to differentiate those services which are highly delay and jitter sensitive so as to assign priority to certain types of services. Although new standard specifications such as IEEE 802.11e provide for such classification, legacy systems that do not implement IEEE 802.11e have no such mechanism. Thus, delay sensitive services must compete with other types of traffic, such as Internet and background traffic.

In congestion situations, services which are highly sensitive to delay and jitter will be the first to experience poor quality. Congestion mechanisms may downgrade these services, although they should be considered as high priority services. In addition, a scheduling scheme that down-prioritizes users with a low signal-to-noise ratio (SNR) may inadvertently down-prioritize “high priority” services.

There are currently mechanisms in the IEEE 802.11e standard that provide a classification mechanism. Applications can request a high priority service from a medium access control (MAC). However, the IEEE 802.11e standard does not support legacy IEEE 802.11a/b/g systems. In addition, the mechanism in the IEEE 802.11e standard depends on the application for implementing classification process. If the application does not fully support the IEEE 802.11e standard or does not provide a classification, it is not possible to determine whether the service is delay and jitter sensitive.

### SUMMARY

The present invention is related to a communication network which includes at least two nodes that exchange data packets. The communication network further includes a processor and a data transmission scheduling unit. The processor monitors the data packets, collects and analyzes information contained in the data packets, and identifies a particular service based on the monitoring of the data packets and the analysis of the information contained in the data packets. The data transmission scheduling unit schedules the transmission of data packets exchanged between the nodes based on a predefined traffic data pattern model selected by the processor from a plurality of predefined traffic data pattern models which is most appropriate for the identified service. Alternatively, a neural network is used to identify the service and select the most appropriate traffic data pattern model used by the data transmission scheduling unit to schedule the transmission of the data packets.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows an exemplary network that uses a traffic data pattern model selected from a predefined model library to schedule data transmissions between at least two nodes in accordance with one embodiment of the present invention;

FIG. 2 shows an exemplary network that includes a neural network which analyzes and selects a traffic data pattern model used to schedule data transmissions between at least two nodes in accordance with another embodiment of the present invention; and

FIG. 3 is a flow diagram of a process for scheduling data transmissions between at least two nodes in either of the networks of FIGS. 1 and 2.

### DETAILED DESCRIPTION OF THE PREFERRED EMBODIMENTS

The present invention is applicable to any communication systems including, but not limited to, IEEE 802.11-based wireless networks.

The features of the present invention may be incorporated into an integrated circuit (IC) or be configured in a circuit comprising a multitude of interconnecting components.

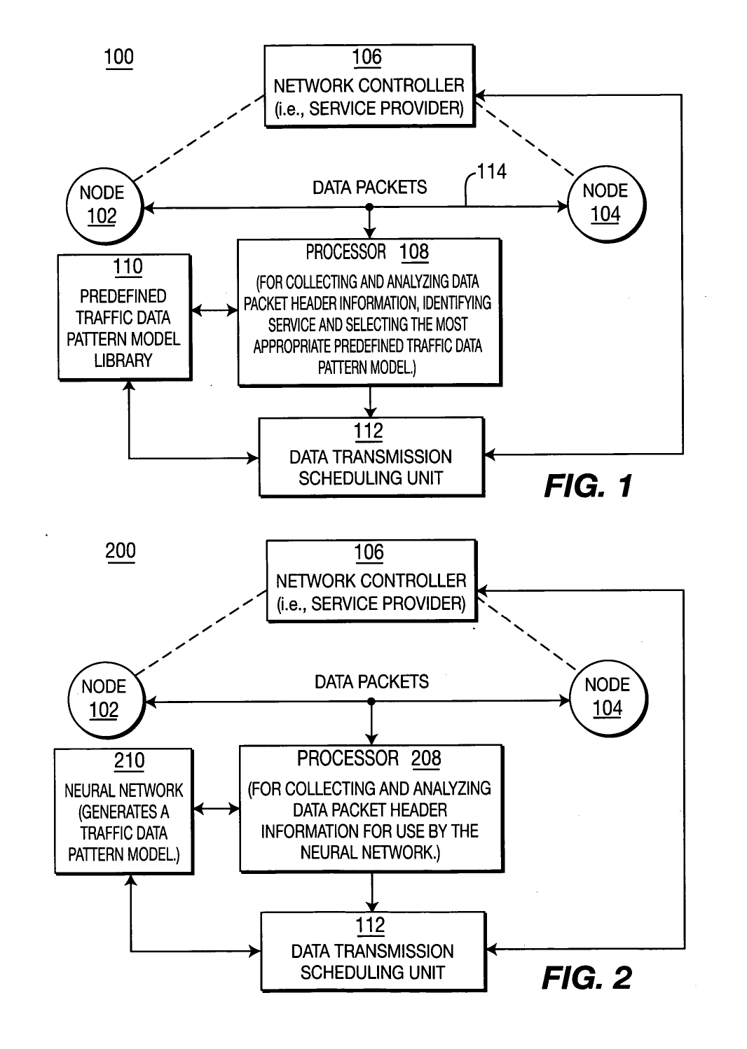

FIG. 1 is an exemplary block diagram of a network 100 that uses a traffic data pattern model selected from a predefined model library to schedule data transmissions between at least two nodes in accordance with one embodiment of the present invention. The network 100 includes a first node 102, a second node 104, a network controller, (i.e., service provider), 106, a processor 108, a predefined traffic data pattern model library 110 and a scheduling unit 112. The processor 108 monitors data packets 114, (i.e., physical layer convergence protocol (PLCP) protocol data units (PPDUs)), which are exchanged between the first node 102 and the second node 104. The processor 108 collects and analyzes information included in headers of the data packets, (e.g., IEEE 802.11 data frame (MAC protocol data units (MPDUs)), MAC data frames, Internet protocol (IP) header, transmission control protocol (TCP) header), to identify, (i.e., classify), a particular service, (i.e., traffic stream) associated with each of the data packets 114. Based on the analysis performed by the processor 108, the processor 108 selects the most appropriate predefined traffic data pattern model from the predefined traffic data pattern model library 110. The data transmission scheduling unit 112 operates in conjunction with the network controller 106 to schedule the transmission of the data packets 114 between the first node 102 and the second node 104 based on the selected predefined traffic data pattern model.

At least one of the processor 108, the predefined traffic data pattern model library 110 and the data transmission scheduling unit 112 may be incorporated into the network controller 106. The processor 108 and the predefined traffic data pattern model library 110 may be combined to form a single entity either external to or within the network controller 106. The processor 108 may include a memory (not shown) for storing information collected from the data packets 114.

The predefined model library 110 may include predefined categories for a plurality of application services in terms of associated parameters. The application services include, but are not limited to, data, voice, image, video, e-mail, web-browsing, file transfer, background or any other applications.

Each application service can be characterized in terms of associated parameters. The parameters include, but are not limited to, a duty cycle, a peak and average throughput, a mean connection time, size of payload, jitter, or the like. For example, a voice service can be characterized as having a 50% duty cycle, (i.e., approximately equal number of packets in both uplink and downlink), a mean connection time of 120 seconds, approximately 50 packets per second, very small payload, (e.g., about 80 to 160 bytes), very little jitter and a low application throughput, or the like. Similarly, data, image, video, e-mail, file transfer, web browsing, background or all other services may also be characterized in terms of the parameters associated with each service.

The processor 108 may monitor the direction of the data packets 114, the frequency of the data packets 114, (e.g., the number of packets transmitted per second in each direction), jitter in receiving or sending the data packets 114, (e.g., whether two packets are received per second, or whether sometimes no packets are received per second), the size of the MPDU of the data packets 114, the life of the identified service, (i.e., traffic stream), or any other relevant information.

This information can be obtained by analyzing the information in the header of the data packets 114, e.g., the IP header and the TCP header. A MAC header of the MPDU may include a source address, a destination address and data size, (i.e., maximum segment size (MSS)). The IP header has fields to indicate the type of service, a source IP address and a destination IP address. The TCP header includes a source port and a destination port, among others.

Using the obtained information, an application service between the source node and the destination node can be identified in accordance with the predefined categories by the processor 108 operating in conjunction with the predefined traffic data pattern model library 110. If sufficient statistics are collected from the MPDUs of the on-going service, the service can be matched to one of the predefined models in the model library 110, and the most appropriate predefined model is selected.

By classifying each service, the services can be prioritized by the scheduling unit 112 and the priority of each service can be managed appropriately. For example, in congestion situations, the scheduling unit 112 may keep some services and remove other services, or may down-prioritize some of the services. By identifying the type of service, a basis for determining which services to keep or terminate or which services to down-prioritize is provided.

For example, if a higher priority is given to users that have higher signal-to-noise ratio (SNR) to improve overall system throughput, a detrimental effect will result on high priority users with a low SNR. In accordance with the scheduling scheme of the present invention, such situations are avoidable. Alternatively, powerful and sophisticated compression algorithms can be used to minimize the size of the data required for the service and to improve the end-user perception.

FIG. 2 is an exemplary block diagram of a network 200 which includes a neural network 210 which analyzes and selects a traffic data pattern model used to schedule data transmissions between at least two nodes in accordance with one embodiment of the present invention. The network further includes a first node 102, a second node 104, a network controller, (i.e., service provider), 106, a processor 208 and a scheduling unit 112. The processor 208 monitors data packets 114, (i.e., PPDUs), which are exchanged between the first node 102 and the second node 104. The processor 208 collects and analyzes information included in headers of the data packets, (e.g., IEEE 802.11 data frame (MPDUs), MAC data frames, IP header, TCP header), associated with each of the data packets 114. Based on the collected information and/or analysis performed by the processor 208, the neural network 210 inherently selects a traffic data pattern model which is used by the data transmission scheduling unit 112 to schedule the transmission of the data packets 114 between the first node 102 and the second node 104.

At least one of the processor 208, the neural network 210 and the data transmission scheduling unit 112 may be incorporated into the network controller 106. The processor 208 and the neural network 210 may be combined to form a single entity either external to or within the network controller 106. The processor 208 may include a memory (not shown) for storing information collected from the data packets 114.

Operating in conjunction with the processor 208, the neural network 210 analyzes and selects a traffic data pattern model. The neural network 210 is an information processing paradigm that is inspired by the way biological nervous systems, (such as brain), process information. The key element of this paradigm is a structure of the information processing system. The neural network 210 comprises a large number of highly interconnected processing elements (neurons) working in unison to solve specific problems. The neural network 210 learns by example through a learning process and is configured for a specific application. For example, the neural network 210 may be used for pattern recognition or data classification. A learning process involves adjustments to the synaptic connections that exist between the neurons. Once trained, the neural network 210 may can be thought of as an “expert” in the category of information it has been given to analyze.

For example, the neural network 210 can be trained to recognize a model for voice services. In this case, the neural network 210 may include a training mode to adjust for the network latencies. Similarly, the neural network 210 may also be trained for data, image, video, e-mail, file transfer, web-browsing, background or all other services.

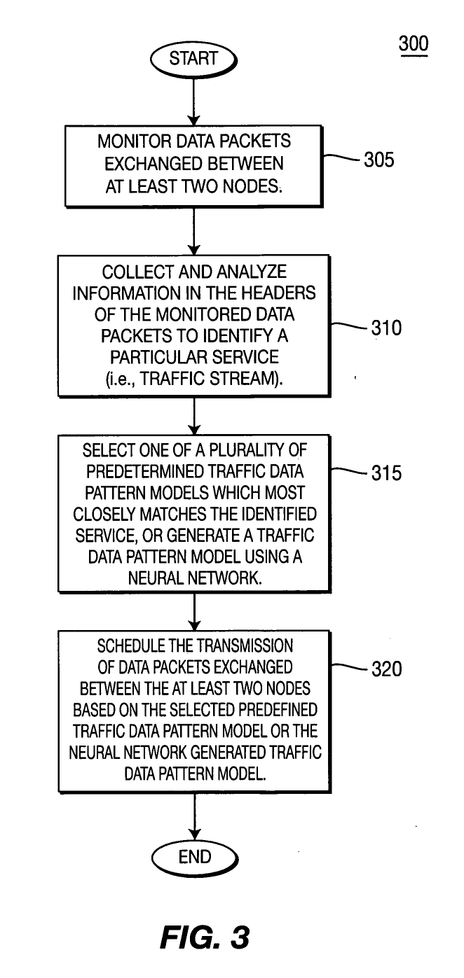

FIG. 3 is a flow diagram of a process 300 including method steps for scheduling data transmissions between the first node 102 and the second node 104 of either of the network 100 of FIG. 1 and the network 200 of FIG. 2. In step 305, the data packets 114 exchanged between the first node 102 and the second node 104 are monitored. In step 310, the information in the headers of the monitored data packets 114 are collected and analyzed to identify a particular service, (i.e., traffic stream). In step 315, one of a plurality of predefined traffic data pattern models in the predefined traffic data pattern model library 110 of the network 100 is selected which most closely matches the identified service, or the information in the headers of the monitored data packets are collected and input into the neural network 210 of the network 200 where the neural network 210 inherently analyzes the data and, based on the model training it has received, identifies and selects the traffic data pattern model which most closely matches the identified services. In step 320, the transmission of data packets 114 exchanged between the first node 102 and the second node 104 is scheduled based on the predefined model selected from the model library 110 or the traffic data pattern model selected by the neural network 210.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a communication network including at least two nodes which exchange data packets, a method of scheduling the transmission of the data packets between the at least two nodes, the method comprising:
(a) monitoring the data packets;
(b) collecting and analyzing information contained in the data packets;
(c) identifying a particular service based on the monitoring of the data packets and the analysis of the information contained in the data packets; and
(d) scheduling the transmission of data packets exchanged between the at least two nodes based on a predefined traffic data pattern model selected from a plurality of predefined traffic data pattern models which is most appropriate for the identified service.

2. The method of claim 1 wherein the information is obtained from an IEEE 802.11 data frame.

3. The method of claim 1 wherein the information is obtained from a medium access control (MAC) data frame.

4. The method of claim 1 wherein the information is obtained from a transmission control protocol (TCP) header.

5. The method of claim 1 wherein the information is obtained from an Internet protocol (IP) header.

6. The method of claim 1 wherein the data packets are medium access control (MAC) protocol data units (MPDUs).

7. The method of claim 1 wherein the particular service is a data service.

8. The method of claim 1 wherein the particular service is a voice service.

9. The method of claim 1 wherein the particular service is a video service.

10. The method of claim 1 wherein the particular service is an image service.

11. The method of claim 1 wherein the particular service is an e-mail service.

12. The method of claim 1 wherein the particular service is a web-browsing service.

13. The method of claim 1 wherein the particular service is a file transfer service.

14. The method of claim 1 wherein step (a) further comprises monitoring the direction that the data packets travel.

15. The method of claim 1 wherein step (a) further comprises monitoring the number of packets transmitted per second in each direction.

16. The method of claim 1 wherein step (a) further comprises monitoring the jitter in receiving or sending the data packets.

17. The method of claim 1 wherein the data packets include medium access control (MAC) protocol data units (MPDUs) and step (a) further comprises monitoring the size of the MPDUs.

18. The method of claim 1 wherein the plurality of predefined traffic data pattern models are stored in a model library.

19. The method of claim 18 wherein the particular service is identified based on at least one of duty cycle, mean connection time, throughput, size of payload and jitter.

20. The method of claim 1 wherein the information contained in the data packets includes source address, destination address and data size.

21. The method of claim 20 wherein the data size is a maximum segment size (MSS).

22. The method of claim 1 wherein step (d) further comprises prioritizing the identified service with respect to other services.

23. The method of claim 22 wherein step (d) further comprises changing the priority of at least one service.

24. The method of claim 22 wherein step (d) further comprises terminating at least one service.

25. In a communication network including at least two nodes which exchange data packets, a method of scheduling the transmission of the data packets between the at least two nodes, the method comprising:
(a) monitoring the data packets;
(b) collecting and analyzing information contained in the data packets;
(c) using a neural network to identify a particular service based on the monitoring of the data packets and the analysis of the information contained in the data packets; and
(d) scheduling the transmission of data packets exchanged between the at least two nodes based on a traffic data pattern model which is most appropriate to the identified service

26. The method of claim 25 wherein the information is obtained from an IEEE 802.11 data frame.

27. The method of claim 25 wherein the information is obtained from a medium access control (MAC) data frame.

28. The method of claim 25 wherein the information is obtained from a transmission control protocol (TCP) header.

29. The method of claim 25 wherein the information is obtained from an Internet protocol (IP) header.

30. The method of claim 25 wherein the data packets are medium access control (MAC) protocol data units (MPDUs).

31. The method of claim 25 wherein the neural network is trained to develop a model for a data service.

32. The method of claim 25 wherein the neural network is trained to develop a model for a voice service.

33. The method of claim 25 wherein the neural network is trained to develop a model for a video service.

34. The method of claim 25 wherein the neural network is trained to develop a model for an image service.

35. The method of claim 25 wherein the neural network is trained to develop a model for an e-mail service.

36. The method of claim 1 wherein the neural network is trained to develop a model for a web-browsing service.

37. The method of claim 25 wherein the neural network is trained to develop a model for a file transfer service.

38. The method of claim 25 wherein step (a) further comprises monitoring the direction that the data packets travel.

39. The method of claim 25 wherein step (a) further comprises monitoring the number of packets transmitted per second in each direction.

40. The method of claim 25 wherein step (a) further comprises monitoring the jitter in receiving or sending the data packets.

41. The method of claim 25 wherein the data packets include MAC protocol data units (MPDUs) and step (a) further comprises monitoring the size of the MPDUs.

42. The method of claim 25 wherein the information contained in the data packets includes source address, destination address and data size.

43. The method of claim 42 wherein the data size is a maximum segment size (MSS).

44. A communication network comprising:
(a) a first node;
(b) a second node which exchanges data packets with the first node;
(c) a processor for monitoring the data packets, collecting and analyzing information contained in the data packets, and identifying a particular service based on the monitoring of the data packets and the analysis of the information contained in the data packets;
(d) a predefined traffic data pattern model library which maintains a plurality of predefined traffic data pattern models; and
(e) a data transmission scheduling unit for scheduling the transmission of data packets exchanged between the first and second nodes based on a predefined traffic data pattern model selected by the processor from the plurality of predefined traffic data pattern models which is most appropriate for the identified service.

45. The communication network of claim 44 further comprising:
(f) a network controller in communication with the first and second nodes, wherein the network controller includes at least one of the processor, the predefined traffic data pattern model library and the data transmission scheduling unit.

46. The communication network of claim 44 wherein the information is obtained from an IEEE 802.11 data frame.

47. The communication network of claim 44 wherein the information is obtained from a medium access control (MAC) data frame.

48. The communication network of claim 44 wherein the information is obtained from a transmission control protocol (TCP) header.

49. The communication network of claim 44 wherein the information is obtained from an Internet protocol (IP) header.

50. The communication network of claim 44 wherein the data packets are medium access control (MAC) protocol data units (MPDUs).

51. The communication network of claim 44 wherein the particular service is a data service.

52. The communication network of claim 44 wherein the particular service is a voice service.

53. The communication network of claim 44 wherein the particular service is a video service.

54. The communication network of claim 44 wherein the particular service is an image service.

55. The communication network of claim 44 wherein the particular service is an e-mail service.

56. The communication network of claim 44 wherein the particular service is a web-browsing service.

57. The communication network of claim 44 wherein the particular service is a file transfer service.

58. A communication network comprising:
(a) a first node;
(b) a second node which exchanges data packets with the first node;
(c) a processor for monitoring the data packets and collecting and analyzing information contained in the data packets;
(d) a neural network for identifying a particular service and selecting a data traffic model based on the monitoring of the data packets and the analysis of the information contained in the data packets;
(e) a data transmission scheduling unit for scheduling the transmission of data packets exchanged between the first and second nodes based on the traffic data pattern model selected by the neural network.

59. The communication network of claim 58 further comprising:
(f) a network controller in communication with the first and second nodes, wherein the network controller includes at least one of the processor, the neural network and the data transmission scheduling unit.

60. In a communication network including a network controller in communication with at least two nodes which exchange data packets, the network controller including an integrated circuit (IC) comprising:
(a) a processor for monitoring the data packets, collecting and analyzing information contained in the data packets, and identifying a particular service based on the monitoring of the data packets and the analysis of the information contained in the data packets;
(b) a predefined traffic data pattern model library which maintains a plurality of predefined traffic data pattern models; and
(c) a data transmission scheduling unit for scheduling the transmission of data packets exchanged between the first and second nodes based on a predefined traffic data pattern model selected by the processor from the plurality of predefined traffic data pattern models which is most appropriate for the identified service.

61. The IC of claim 60 wherein the information is obtained from an IEEE 802.11 data frame.

62. The IC of claim 60 wherein the information is obtained from a medium access control (MAC) data frame.

63. The IC of claim 60 wherein the information is obtained from a transmission control protocol (TCP) header.

64. The IC of claim 60 wherein the information is obtained from an Internet protocol (IP) header.

65. The IC of claim 60 wherein the data packets are medium access control (MAC) protocol data units (MPDUs).

66. The IC of claim 60 wherein the particular service is a data service.

67. The IC of claim 60 wherein the particular service is a voice service.

68. The IC of claim 60 wherein the particular service is a video service.

69. The IC of claim 60 wherein the particular service is an image service.

70. The IC of claim 60 wherein the particular service is an e-mail service.

71. The IC of claim 60 wherein the particular service is a web-browsing service.

72. The IC of claim 60 wherein the particular service is a file transfer service.

73. In a communication network including a network controller in communication with at least two nodes which exchange data packets, the network controller including an integrated circuit (IC) comprising:
(a) a processor for monitoring the data packets and collecting and analyzing information contained in the data packets;
(b) a neural network for analyzing and selecting a traffic data pattern model library based on the monitoring of the data packets and the analysis of the information contained in the data packets; and
(c) a data transmission scheduling unit for scheduling the transmission of data packets exchanged between the first and second nodes based on the traffic data pattern model generated by the neural network.
